(19) United States
(12) Patent Application Publication
(10) Pub. No.: US 2002/0180762 A1
(43) Pub. Date: Dec. 5, 2002

(54) Method for changing display direction in a portable telephone

(76) Inventor: Jong-Chul Lee, Kumi-shi (KR)

Correspondence Address: Paul J. Farrell, Esq., DILWORTH & BARRESE, LLP, 333 Earle Ovington Blvd., Uniondale, NY, 11553, US

(21) Appl. No.: 09/994,565

(22) Filed: Nov. 27, 2001

(30) Foreign Application Priority Data
Jun. 1, 2001 (KR) 2001-30912

(51) Int. Cl. G09G 5/00

(52) U.S. Cl. 345/649

(57) ABSTRACT

There is disclosed a method for changing an image display direction of a display in a portable telephone comprising the steps of determining whether a display direction change mode is selected while displaying an image in a predetermined display direction through the display and changing the display direction if the display direction change mode is selected.

### PRIORITY

This application claims priority to an application entitled “Method for Changing Display Direction in a Portable Telephone” filed in the Korean Industrial Property Office on Jun. 1, 2001 and assigned Serial No. 2001-30912, the contents of which are hereby incorporated by reference.

### BACKGROUND OF THE INVENTION

1. Field of the Invention

The present invention relates generally to a portable telephone, and in particular, to a method for changing an image display direction of a display in a portable telephone.

2. Description of the Related Art

In general, portable telephones are classified as flip type or folder type. A flip-type portable telephone typically has an LCD (Liquid Crystal Display) mounted on its main body and a folder-type portable telephone typically has its LCD mounted on its sub-body. In order to satisfy users' various desires, an improved folder-type portable telephoneadopting a dual LCD to make up for the defects of the conventional folder-type portable telephone has been developed. Like the flip-type portable telephone, the dual-LCD folder-type portable telephone enables a user to see its operating status through an outer LCD even when a folder (or a sub-body) is folded.

Meanwhile, owing to consumers' desire and the intense rivalry between manufacturers, portable telephones are able to provide various supplementary functions in addition to the fundamental voice call function. Accordingly, portable telephones are presently able to provide myriad personal information and wireless data communication services, and have gained wide popularity and become an always-carried necessary article in modem life. Numerous products exist that enable a user to carry and to use portable telephones more conveniently. To give a typical example, there is proposed a necklace for a portable telephone, which can be attached to the portable telephone and hung around the user's neck, lanyard style with the necklace supporting the portable phone. The portable telephone necklace will also support an earphone and a call key, which enable the user to conveniently enjoy the voice call service without removing the portable telephone from the necklace and without removing the necklace from the user's neck. In addition, the user can utilize the necklace-supported portable phone to enjoy various wireless data communication services and personal information services, such as checking the time, accessing messages, and scheduling management services, all by viewing the outer LCD of the portable telephone (whether of flip or folder type).

Moreover, portable telephones are expected to become increasingly smaller and lighter, a change that will inspire more users to hang the portable telephone on their necks using the portable telephone necklace.

In short, when the user enjoys the personal information service and the wireless data communication service using the portable telephone hung on his neck through the portable telephone necklace, there will be an increasing need for users to be able to visually perceive the data that is presented through the outer LCD of the portable telephone in a more convenient manner.

However, when the user desires to check data such as the time or a received message using the portable telephone hung on his neck through the portable telephone necklace, the user must either physically reposition the portable telephone or look down at the portable telephone and attempt to decipher the upside-down and backwards image. μs conventional portable telephones can display an image on the LCD in only one direction, absent repositioning, the user will have difficulty visually perceiving the upside-down and backwards (i.e., inversely displayed) image.

### SUMMARY OF THE INVENTION

It is, therefore, an object of the present invention to provide a method for changing a display direction of a display in a portable telephone.

It is another object of the present invention to provide a method for enabling a user to easily perceive an image displayed on an inverted display screen of a portable telephone hung on the user's neck through a portable telephone necklace.

It is yet another object of the present invention to provide a method for changing a display direction of a display in a portable telephone worn on a user's belt, allowing the user to more easily perceive an image displayed on an inverted display screen of the portable telephone.

To achieve the above and other objects, there is provided a method for either manually or automatically changing an image display direction of a display in a portable telephone. The display direction changing method comprises the steps of determining whether a display direction change mode is selected while displaying an image in a predetermined display direction through the display and changing the display direction if the display direction change mode is selected.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a scheme for controlling a display direction of an LCD in a portable telephone according to an embodiment of the present invention;

FIGS. 2(a) and (b) are diagrams illustrating a necklace-type carrying device and the image displayed on the LCD screen of the portable telephone according to an embodiment of the present invention;

FIGS. 3(a) and (b) are detailed diagrams illustrating images displaying the pixels that make up the image on the LCD screen of the portable telephone according to an embodiment of the present invention; and

FIG. 4 is a flowchart illustrating a control procedure for changing a display direction of the LCD screen in the portable telephone according to an embodiment of the present invention.

### DETAILED DESCRIPTION OF THE PREFERRED EMBODIMENT

The following detailed description of a preferred embodiment of the invention will be made in reference to the accompanying drawings. In describing the invention, explanation about related functions or constructions which are known to the art, will be omitted for the sake of clearness in understanding the concept of the invention. The following preferred embodiments of the present invention will be described herein below with reference to the accompanying drawings. In the following description, well-known functions or constructions are not described in detail since they would obscure the invention in unnecessary detail.

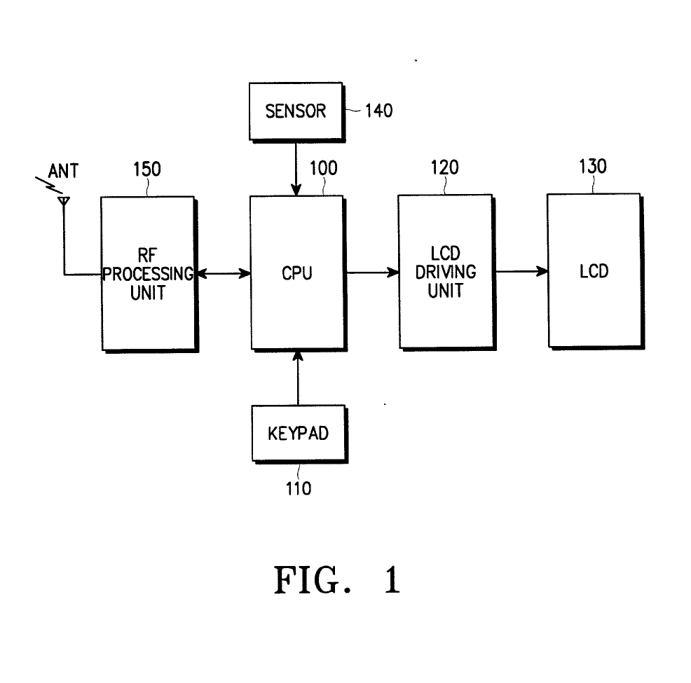

FIG. 1 is a block diagram illustrating a scheme for controlling a display direction of an LCD in a portable telephone according to an embodiment of the present invention. Referring to FIG. 1, a CPU (Central Processing Unit) 100 controls the overall operation of the portable telephone. In particular, the CPU 100 generates an LCD driving control signal for changing a display direction of an LCD 130 in response to an input signal from a keypad 110 and a sensing signal from a sensor 140. The keypad 110 has a plurality of numeral keys for dialing and a plurality of function keys for special functions.

In particular, the keypad 110 has a mode selection key to allow the user to change a display direction of the LCD 130 according to an embodiment of the present invention. The mode selection key is a kind of function key, which is used for changing an LCD display direction by 180°, by reversing LCD display positions horizontally and vertically so as to enable the user to perceive the image displayed on the LCD 130 of the portable telephone from its expected perspective (i.e., with characters and other images in their normal and upright position), even when the portable telephone is turned upside down. The mode selection key can be mounted either on the keypad 110 or in a main body of the portable telephone so that the user can easily access it without opening the folder or flip type portable telephone. Alternatively, the mode selection key can also be realized using a volume key.

Depending on the LCD driving control signal from the CPU 100, an LCD driving unit 120 drives the LCD 130 to display information such an operation state of the portable telephone and/or dialing data. The LCD driving unit 120 comprises an LCD driver and its peripheral circuitry necessary for operation of the LCD driver. Under the control of the CPU 100, an RF (Radio Frequency) processing unit 150 modulates a voice signal inputted through a microphone (not shown) into a radio signal and demodulates a radio signal received through an antenna ANT to output the demodulated signal through a speaker (not shown).

The sensor 140 senses a connection state of an earphone jack and preferably will also function to sense whether the portable telephone is inverted relative to the display direction, which is detected by a gravity sensor or similar device or circuitry that is typically installed within the portable telephone, and provides the resultant sensing signal to the CPU 100.

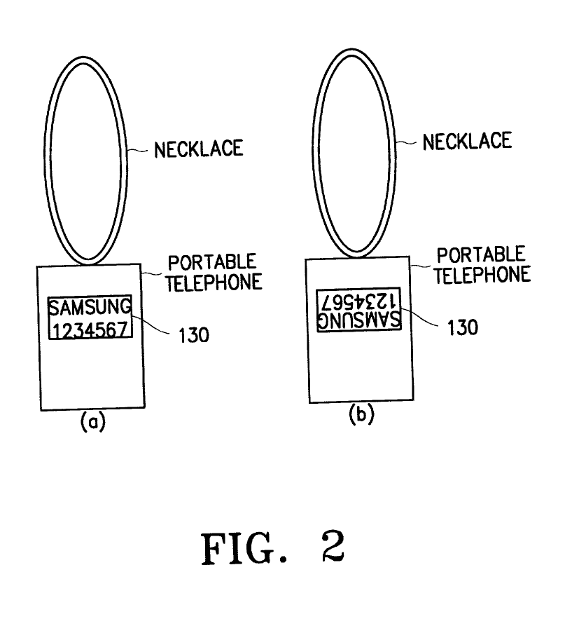

FIG. 2 provides diagrams illustrating images displayed on an LCD screen of the portable telephone according to an embodiment of the present invention. More specifically, FIG. 2A shows an LCD screen before a change of the display direction, and FIG. 2B illustrates the LCD screen after a change of the display direction.

As shown in FIG. 2, if a display direction change request signal is generated by a display direction change mode selection key, an earphone jack or a gravity sensor, then a display direction of the LCD 130 is changed by 180°0. Consequently, through the display direction change function of the portable telephone, the user can easily perceive whatever image is displayed on the LCD 130 of the inverted portable telephone attached to his waist belt or the portable telephone necklace hung around his neck.

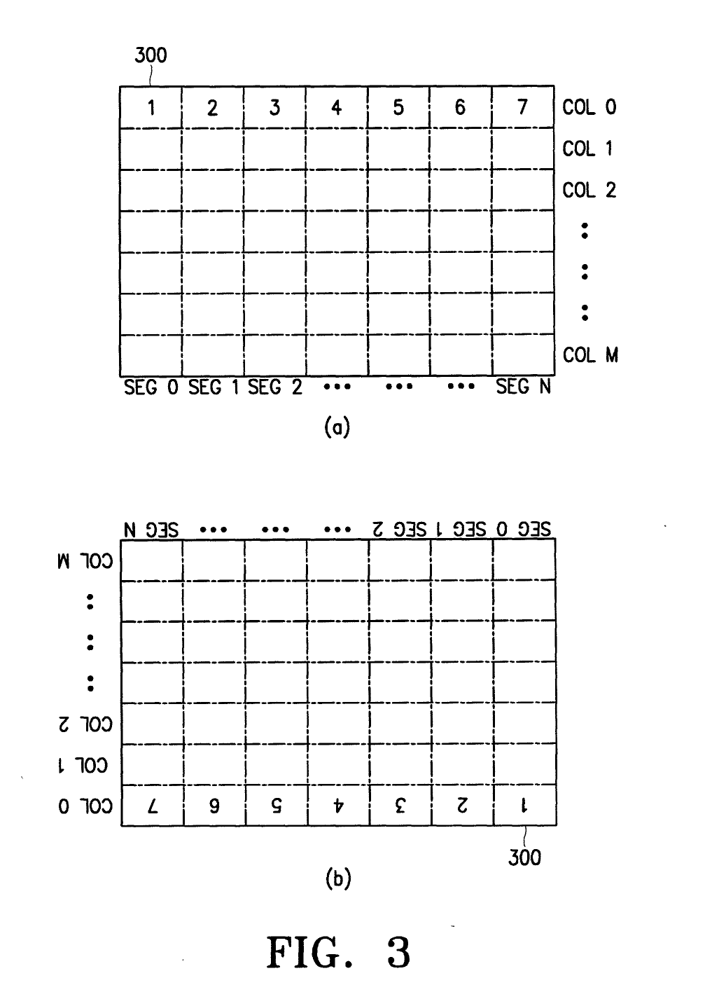

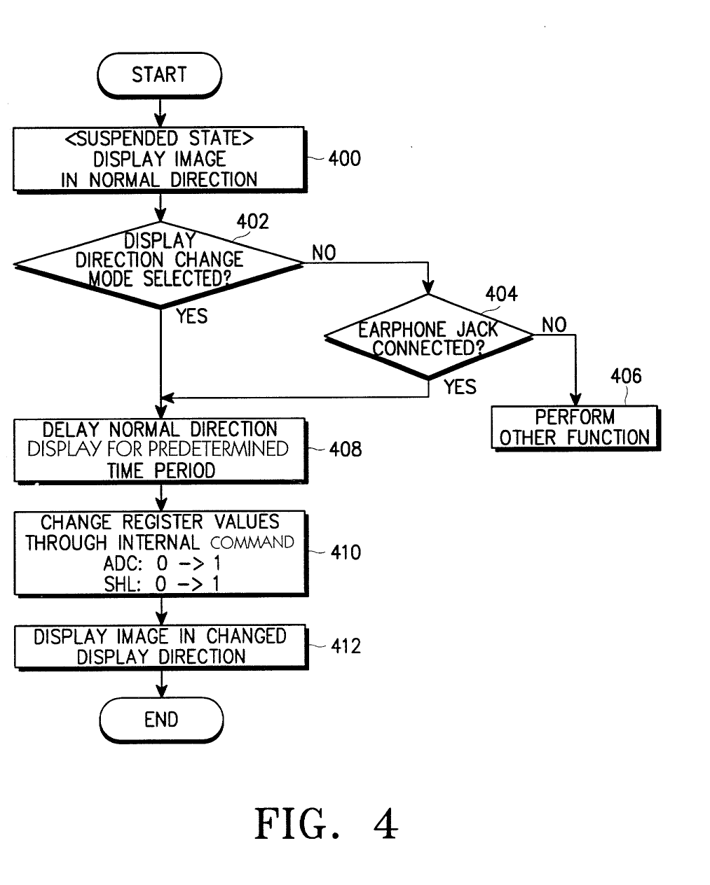

FIG. 3 provides detailed diagrams illustrating images displayed on the LCD screen of the portable telephone according to an embodiment of the present invention, and FIG. 4 is a flowchart illustrating a control procedure for changing a display direction of the LCD screen in the portable telephone according to an embodiment of the present invention. The display direction changing method according to the present invention will now be described in detail with reference to FIGS. 3 and 4.

Referring to FIGS. 3(a) and (b), an LCD screen of the portable telephone is horizontally divided into (N+1) segments and vertically divided into (M+1) columns, and a segment number and column number are assigned to each portion of the display. In the LCD display direction changing method of the present invention, a display position 300 corresponding to coordinates (SEG 0, COL 0) shown in FIG. 3A is changed to a display position 300′ corresponding to coordinates (SEG 0, COL 0) shown in FIG. 3B.

Referring to FIG. 4, in a portable telephone having an outer LCD, the CPU 100 normally displays an image on the LCD when the portable telephone is in a suspended or standby state (Step 400). The CPU 100 determines in steps 402 and 404 whether an LCD display direction change mode is selected. The LCD display direction change mode is determined to have been selected either: (1) when the user presses a mode selection key; or (2) when the user takes some other predetermined action, such as connecting an earphone to the jack on the portable telephone; or (3) when an internal sensor detects that the user has inverted the portable telephone, such as through the provision of a gravity sensor installed at an upper end of the main body of the portable telephone. If the display change mode is not selected, other intended functions may be performed at step 406. If it is determined in either of steps 402 and 404 that the LCD display direction change mode is selected, an LCD display direction change mode selection signal will be generated and the CPU 100 proceeds to step 408. In step 408, the CPU 100 regards the LCD display direction change mode selection signal as an interrupt signal and delays (continues) the operation of displaying the image in the normal display direction for a predetermined time period. The CPU 100 will then perform step 410, changing the register values, as described in FIG. 3, above.

In step 410, the CPU 100 changes values of LCD display direction selection registers in response to an internal command. The LCD display direction selection register values are changed by reversing both an output display direction of the LCD segments and columns. In FIG. 4, “ADC” of step 410 indicates a register for selecting an output direction of the segments shown in FIGS. 3(a) and (b), and “SHL” of step 410 indicates a register for selecting an output direction of the columns shown in FIGS. 3(a) and (b). The values of the ADC and the SHL are set to “0”in the normal operation state shown in FIG. 3(a). If these register values are changed to “1”, the output directions of the segments and columns are reversed as shown in FIG. 3(b). That is, when the LCD display direction is changed according to the present invention, the ADC and SHL register values are changed to “1”.

As shown in FIG. 3(b), the display direction of the LCD segments is reversed according as the ADC register value changes from “0” to “1”, and the display direction of the LCD columns is also reversed according as the SHL register value changes from “0” to “1”. As a result, the LCD screen will be displayed with its right and left segments reversed and with its top and bottom segments reversed. For example, the display position 300 corresponding to coordinates (SEG 0, COL 0) in FIG. 3(a) is changed to a display position 300′ corresponding to coordinates (SEG 0, COL 0) shown in FIG. 3(b).

In step 412, the CPU 100 displays the LCD screen in the changed display direction according to the changed values of the display direction selection registers. As a result, the LCD screen of FIG. 3(a) is changed to the LCD screen of FIG. 3(b) .

As described above, the present invention provides an LCD display direction changing method for a portable telephone having an outer LCD, wherein an LCD display direction change mode is selected (1) when the user presses an exterior function key for selecting the LCD display direction change mode, (2) when the user connects an earphone jack to the portable telephone, or (3) when inversion of the portable telephone is sensed through a sensor. Such as a gravity sensor, preferably installed at the upper end of the main body of the portable telephone. Therefore, the user can easily perceive the image inversely displayed on the LCD display of the portable telephone attached to his waist belt or on a necklace hung around his neck

While the invention has been shown and described with reference to certain preferred embodiments thereof, it will be understood by those skilled in the art that various changes in form and details may be made therein without departing from the spirit and scope of the invention as defined by the appended claims. It will be appreciated by one of ordinary skill in the art that the present invention is not limited to necklace-type carrying devices and that it will also function with and will be useful for carrying a portable phone, for example, on a waist belt holder.

What is claimed is:

1. A method for changing a display direction of a display for displaying an image in a portable telephone, comprising the steps of:
displaying the image on the display in a predetermined display direction;
determining whether a display direction change mode is selected, while displaying the image in the predetermined display direction; and
changing the display direction if it is determined that the display direction change mode is selected.

2. The method as claimed in claim 1, wherein a user selects the display direction change mode by pressing a key.

3. The method as claimed in claim 1, wherein a user selects the display direction change mode by connecting an earphone jack to the portable telephone.

4. The method as claimed in claim 1, wherein the display direction change mode is determined by inversion of the portable telephone.

5. The method as claimed in claim 4, wherein inversion of the portable telephone is sensed through a gravity sensor.

6. The method as claimed in claim 2, wherein the display direction changing step comprises the steps of:
continuing to display the image in the predetermined display direction for a predetermined time period;
changing a value of at least one display direction selection register; and
displaying the image in a changed display direction according to the changed value of the at least one display direction selection register.

7. The method as claimed in claim 6, wherein the display direction selection register value is changed by reversing both an output direction of segments and an output direction of columns.
